(19) United States
(12) Patent Application Publication
(10) Pub. No.: US 2022/0101748 A1
(43) Pub. Date: Mar. 31, 2022

(54) Attention training method and system based on synergic control of breathing and force

(71) Applicant: BEIHANG UNIVERSITY, Beijing (CN)

(72) Inventors: Dangxiao WANG, Beijing (CN); Yilei ZHENG, Beijing (CN); Shiyi LIU, Beijing (CN); Yuru ZHANG, Beijing (CN)

(21) Appl. No.: 17/424,161

(22) PCT Filed: Jan. 3, 2020
(86) PCT No.: PCT/CN2020/070288

§ 371 Date: Jul. 20, 2021

(30) Foreign Application Priority Data
Jan. 28, 2019 (CN) 201910080456.6

(51) Int. Cl. G09B 19/00

(52) U.S. Cl. CPC G09B 19/00

(57) ABSTRACT

The present invention relates to an attention training method and system based on synergic control of breathing and force, combining the characteristics of focusing on proprioceptive breathing during meditation with the characteristics of focusing on muscle force control in the haptic channel, realizing visual detection of attention states during training through synchronization errors of breathing signals and force signals; the method comprises four subtasks, have progressively increasing training difficulty and can be used for training independently or consecutively in a progressive manner, also includes an training system for implementing the training method; the attention training is achieved through this continuous synergic control tasks of breathing and force, and the attentional state during the training is reflected by a synchronization error of the breathing signal and a muscle force output signal. If the calculated synchronization error exceeds a given threshold, the system generates an alert representing a low attention level.

### TECHNICAL FIELD

This present invention relates to an attention training method and system, in particular, to an attention training method and system based on synergic control of breathing and force.

### BACKGROUND

There is an urgent need to train and improve attention in many areas. For example, for those with Attention Deficit Disorder (ADD), the main symptoms are inability to decide the time and occasions to focus, and being unconsciously distracted, which seriously affects normal life, learning and work, and even about 65% of children with ADD have symptoms that persist into adulthood and are at higher risk of substance dependence, antisocial personality disorder and crimes than the normal people. In addition, for special professionals working in high stress environments, such as pilots, race car drivers, and air traffic controllers in airport towers etc., they need to concentrate for long periods of time in order to quickly process large amounts of information and make correct decisions, because momentary loss of attention may lead to catastrophic consequences. For people working in mental occupations, the ability to concentrate can affect the effectiveness of learning, the quality of scientific research, and the experience of well-being in daily life.

Most of the existing attention training systems are mainly in the form of audiovisual games, such as the Luminosity game, and the attention training games for children in utility model patents CN205127306U and CN203838907U. It is found that the attention training systems in the form of audiovisual games can effectively improve the attention control ability of people, but the generalization performance is not very good, i.e., the attention improvement obtained through the audiovisual game training is hard to be transferred to other kinds of cognitive activities. Another form of training to improve attention is meditation. Among various meditation methods, the mainstream one is Focused Attention Meditation, the main principle of which is to allow the practitioner to focus all of his or her attention on the experience of his or her own being. For example, the practitioner is asked to focus on his or her own breathing and count silently in each breathing cycle from 1 to 10 and then start counting again from 1. If the practitioner realizes that he or she is distracted during the process, he or she needs to refocus on the breathing and start counting again from 1. With continuous training for months to years, the practitioner's attentional control can be improved. The advantage of meditative attention training is that, it has a good generalizability and pervasiveness. However, a study of current forms of meditation training methods revealed two limitations of existing meditation training methods based on breathing focus. On one hand, meditation is a form of training that involves the inner attention of human beings, and it is difficult to externally observe and evaluate the inner attention state of practitioners in the process of meditation training through objective indicators in real time, so even if practitioners are distracted in the process of meditation training, it is difficult for the trainer to detect and give appropriate reminders in time, thus causing meditation practitioners to be distracted for a lot of time in the daily training, and the time window for them to be in the attentional state is likely much smaller than the length of daily meditation training. On the other hand, the task of breathing attention is rather monotonous, and practitioners are prone to frequent distraction or falling asleep during training. It is difficult to solve the problem of how to mobilize the attention resources of meditation practitioners with high intensity and density to avoid being distracted. Due to the above two limitations, it usually takes months or even years for practitioners to master the ability of attention control and come to the state of efficient meditation training. Due to the long training period and the poor results at the beginning of the training, a large number of meditation beginners lack sufficient patience to learn and master the basic requirements and skills of the practice and give up the training halfway, which makes it difficult to promote meditation practically for more than a thousand years since its introduction.

Based on the mapping relationship between the perception and motor cortex of the brain and the body, it is clear that the haptic channel is a basic and unique sensory channel for human communicating with the outside world, through which human beings can both receive stimulus information and actively output actions. In addition, compared to the privacy and physiological characteristics of direct contact of the haptic channel, the visual and auditory channels are more susceptible to disturbance from extraneous information in the external environment during attention training, resulting in involuntary distractions. In the current attention training methods, the human's natural haptic abilities, including proprioceptive force signal perception and motor/force control, are not effectively utilized.

### SUMMARY

The purpose of the present invention is to overcome the disadvantages of the prior art and to provide an attention training method and system based on synergic control of breathing and force through combining the characteristics of focusing on proprioceptive breathing in meditation training with the characteristics that the haptic channel helps people focus on muscle force control, achieving the monitorability of attention state during training through the synchronization error of breathing signal and force signal, thus to improve the effectiveness of attention training. In addition, the design of progressive subtasks in stages maintains the user's motivation and attention to training, thus achieving the goal of improving the attentional regulation ability of the target population.

The solution in the present invention is:

An attention training method based on synergic control of breathing and force, characterizing by combining the characteristics of focusing on proprioceptive breathing during meditation with the characteristics of focusing on muscle force control in the haptic channel, and realizing visual detection of attention states, during a training process through synchronization errors of breathing signals and force signals, wherein the method comprising:
(a) a breath counting subtask, wherein a practitioner focuses on his or her own breath and counts breathing cycles silently, with one inhalation plus one exhalation being recorded as one breathing cycle; wherein the training method further comprises one or more of the following three subtasks:
(b) a subtask of synchronous increase/decrease of breathing and muscle force, wherein the practitioner focuses on the breathing and the muscle force output at the same time, controls the muscle force output to increase steadily during inhalation, and keeps the muscle force output at the maximum value when the inhalation reaches the limit and a breath-holding state; then controls the muscle force output to decrease steadily during exhalation, and reduces the muscle force output to zero when the exhalation reaches the limit and the breath-holding state;
(c) a subtask of asynchronous increase/decrease of breathing and muscle force, wherein the practitioner focuses on the breathing and the muscle force output at the same time, and the muscle force output decreases to zero when the inhalation reaches the limit and the breath-holding state; controls the muscle force output to increase steadily during exhalation, and keeps the muscle force output at the maximum value when the exhalation reaches the limit and the breath-holding state; and
(d) a subtask of mixed increase/decrease of breathing and muscle force, wherein the practitioner focuses on the breathing and the muscle force output at the same time and switches between the synchronous and asynchronous increase/decrease subtasks in groups of several breathing cycles.

Further, the four subtasks of (a)(b)(c) and (d) have progressively increasing training difficulty and are used for training independently or consecutively in a progressive manner.

Further, the muscle force is a fingertip force.

Further, the practitioner's breathing type is abdominal breathing.

Further, the synchronization error between the breathing signal and the force signal is represented by a “breathing-muscle force synchronization” indicator, which reflects the synchronization between the breathing signal and the muscle force output signal of the practitioner during the training process and is an external representation parameter of the practitioner's internal attention state during the training process.

Further, the “breathing-muscle force synchronization” indicator is obtained by following steps: band-pass filtering and moving average filtering of the raw signals of breathing and muscle force output to remove obvious noise, and segmenting the breathing signals and muscle force output signals according to pre-set appropriate minimum intervals and minimum amplitudes of signal cycles, wherein each breathing cycle or muscle force increase/decrease cycle is divided into one segment, and calculating extreme points in each segment, including the maximum value points and the minimum value points, extracting moments corresponding to the extreme points in each segment, extracting plateau phase near the extreme points by data fitting, and further calculating the beginning and ending moments of the plateau phase in each segment.

The present invention also provides an attention training system based on synergic control of breathing and force, for implementing the above attention training methods, comprising: a main control module, a muscle force acquisition module, a breathing acquisition module, a display module and a feedback module, wherein the muscle force acquisition module and the breathing acquisition module are arranged to be connected to the main control module respectively and the main control module is arranged to be connected to the display module and the feedback module; the muscle force acquisition module is configured to collect muscle force output signals; the breathing acquisition module is configured to collect breathing signals; the main control module is configured to be used to set parameters before the training, to calculate the “breathing-muscle force synchronization” indicator representing the attention state during the training and to detect a low attention level; the display module is configured to display the muscle force output signals, the breathing signals and the “breathing-muscle force synchronization” indicator transmitted from the main control module; the feedback module is configured to feed back the “breathing-muscle force synchronization” indicator representing the low attention level detected by the main control module to the practitioner in real time in the form of short beeps.

The system further comprises a base for holding the muscle force acquisition module.

The system further comprises anti-disturbance equipment for isolating the disturbance of external environment.

Further, the anti-disturbance equipment comprises an anti-noise headset or an eyeshade.

The present invention has the following beneficial effects: since a task of high-precision muscle force control requires real-time force perception of tactile receptors and precise force output of muscle effectors, it requires high-intensity involvement of attention to precisely regulate the activation of muscle motor control neurons, so the muscle force control task can quickly attract the user's attention focus to the tactile proprioception, and this feature helps practitioners to quickly enter and stay in the attentional state and achieve autonomous regulation of the attention state by eliminating external environmental disturbance and internal brain disturbances in the presence of external noise or internal mental stress. In addition, human behavior in force tasks can be accurately and objectively measured, and based on this feature, the internal attention state can be evaluated through real-time feedback by designing interaction tasks of specific difficulty. In addition, the haptic channel has the physiological characteristics of privacy and direct contact, while the visual and auditory channels are more susceptible to disturbance from irrelevant information in the external environment during attention training, resulting in involuntary distractions. If the audiovisual channel is blocked and only the haptic channel is retained for information exchange with the outside world, the practitioner will concentrate more on the haptic channel of the body, thus further developing the user's potential for attention invocation and regulation in performing force control tasks. The present invention accomplishes attention training through these continuous breathing and force synergic control tasks and reflects the attentional state during training through the synchronization error of breathing signal and muscle force output signal. In addition, the design of progressive subtasks in stages helps to maintain the user's motivation and attention to the training, thus improving the attention regulation capabilities of a target population.

### BRIEF DESCRIPTION OF THE DRAWINGS

In order to make the technical solution of the invention clear and complete, a brief description of the drawings in the description of the invention will be given below. It is obvious that the drawings in the following description are only some embodiments of the invention, and that other drawings can be obtained from these drawings without creative work for a person skilled in the art.

FIG. 1 is a schematic diagram of a hardware structure of the present invention;

FIG. 2 shows a schematic diagram of a task process of the embodiment of the present invention;

FIG. 3 shows a flow chart of the “breathing-muscle force synchronization” indicator in the embodiment of the present invention; and

FIG. 4 shows a schematic diagram of the collected signals in the embodiment of the invention;

wherein, the above drawings include the following reference signs: 1. main control module; 2. muscle force acquisition module; 3. breathing acquisition module; 4. display module; 5. feedback module; 6. seat; 7. anti-noise headset; 8. eyeshade; 9. belly band with breathing sensors; 10. pressure sensor; 11. base.

### DETAILED DESCRIPTION

The technical solution of the present invention will be clearly and completely described below in combination of the drawings, and it is clear that the described embodiments are a part of the embodiments of the present invention, and not all of them. Based on the embodiments in the present invention, all other embodiments obtained by a person skilled in the art without creative work fall within the scope of protection of the present invention.

In the description of the present invention, it should be noted that the orientation or position relationship indicated by the terms “center”, “top”, “bottom”, “left”, “right”, “vertical”, “horizontal”, “inside” and “outside” etc. is based on the orientation or position relationship shown in the drawings and is intended only to facilitate and simplify the description of the invention, not to indicate or imply that the device or element referred to must have a particular orientation or be constructed and operate in a particular orientation, and therefore is not to be construed as a limitation of the invention. Furthermore, the terms “first”, “second” and “third” are used for descriptive purposes only and are not to be construed as indicating or implying relative importance.

In the description of the invention, it is to be noted that, unless otherwise expressly specified and limited, the terms “mounted”, “joined” and “connected” are to be understood in a broad sense. For example, it can be a fixed connection, a detachable connection, or a one-piece connection; it can be a mechanical connection or an electrical connection; it can be a direct connection or an indirect connection through an intermediate medium, and it can also be an interconnection of two components. For a person skilled in the art, the specific meaning of the above terms in the present invention can be understood in the context of specific cases.

A method of attention training based on synergic control of breathing and force, characterized in that it combines the characteristics of focusing on proprioceptive breathing during meditation with the characteristics of focusing on muscle force control in the haptic channel, and realizes visual detection of attention states during a training process through synchronization errors of breathing signals and force signals, the training method comprising: (a) a breath counting subtask, in which the practitioner focuses on his or her breathing and counts his or her breathing cycles silently, with one inhalation plus one exhalation being recorded as one breathing cycle; wherein the training method further comprises one or more of the following three subtasks (b) a subtask of synchronous increase/decree of breathing and muscle force, the practitioner focuses on the breathing and the muscle force output at the same time, controls the muscle force output to increase steadily during inhalation, and keeps the muscle force output at the maximum value when the inhalation reaches the limit and a breath-holding state; then controls the muscle force output to decrease steadily during exhalation, and reduces the muscle force output to zero when the exhalation reaches the limit and the breath-holding state; (c) a subtask of asynchronous increase/decree of breathing and muscle force, the practitioner focuses on the breathing and the muscle force output at the same time, and the muscle force output decreases to zero when the inhalation reaches the limit and the breath-holding state; controls the muscle force output to increase steadily during exhalation, and keeps the muscle force output at the maximum value, when the exhalation reaches the limit and the breath-holding state and (d) a subtask of mixed increase/decrease of breathing and muscle force, in which the practitioner focuses on both breathing and muscle force output at the same time, and switches between the synchronous and asynchronous increase/decrease subtasks in groups of several breathing cycles; The four subtasks of (a) (b) (c) and (d) have progressively increasing training difficulty and are used for training independently or consecutively in a progressive manner, and the duration of each subtask can be set respectively or set to a default time through the main control module before the training starts. The muscle force in this embodiment is preferably the fingertip force.

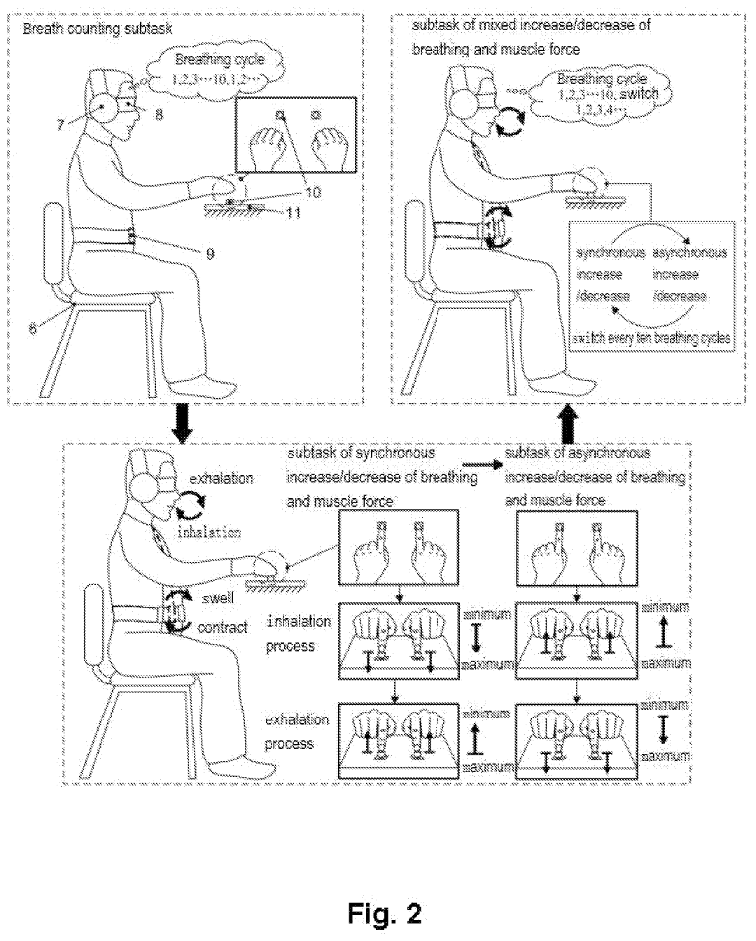

FIG. 2 shows a schematic diagram of an embodiment of the fingertip force training phase of the present invention. In the task of synergic control of breathing and fingertip force in the present invention, the practitioner preferentially chooses to take abdominal breathing, and during the training, the practitioner sits on a seat 6, wears an anti-noise headset 7 and an eyeshade 8 to isolate the visual and auditory disturbance from the external environment; wears a belly band 9 with a breathing sensor at the belly button which is in front of the abdomen, and the belly band 9 with a breathing sensor is worn as tightly as possible under the premise of the practitioner's comfort to ensure stable acquisition of breathing signals. Two pressure sensors 10 are placed at a comfortable distance and height in front of the practitioner, and the two pressure sensors 10 are fixed to the base 11 with a comfortable distance when pressed simultaneously by the index fingers of the left and right hands of the practitioner.

At the beginning of the training, the practitioner begins the breath counting subtask when he or she hears a beep informing that the training is about to begin. In the breath counting subtask, the practitioner focuses on his or her breathing and feels that the abdomen slowly swells during the inhalation and slowly contracts during the exhalation. The practitioner counts his or her breathing cycles silently, one inhalation plus one exhalation is recorded as 1, and after counting silently from 1 to 10, he or she starts counting again from 1. If the practitioner realizes that he or she is distracted during the subtask, he or she refocuses on the breathing and then starts counting again from 1.

In the subtask of synchronous increase/decrease of breathing and muscle force, the practitioner focuses on the breathing and the index fingertips of the left and right hands at the same time to achieve a synergic control of the rhythm of breathing and the pressure force of the index fingertips of the left and right hands. Specifically, the practitioner starts to press the corresponding pressure sensors with the left and right index fingertips simultaneously at the moment of starting inhalation, and controls the pressure force of the left and right index fingertips to increase steadily during the inhalation, and keeps the pressure force of the fingertips at the maximum value when the inhalation reaches the limit and the breath-holding state; then controls the pressure force of the left and right index fingertips to decrease steadily during exhalation, and reduces the pressure force of the fingertips to zero when the exhalation reaches the limit and the breath-holding state. During this subtask, the practitioner needs to focus on the synergic control of the breathing and fingertip force in order to maintain the synchronization between the breathing and increase/decrease of the pressure force of the left and right index fingers.

In the subtask of asynchronous increase/decree of breathing and muscle force, the practitioner controls the pressure force of the fingertips of both index fingers to decrease steadily during the inhalation, and reduces the pressure force of the fingertips to zero when the inhalation reaches the limit and the breath-holding state; during the exhalation process, the practitioner controls the pressure force of the fingertips of both index fingers to increases steadily, and keeps the pressure force of the fingertips at the maximum value when the exhalation reaches the limit and the breath-holding state.

In the subtask of mixed increase/decrease of breathing and muscle force, the practitioner needs to switch between the synchronous increase/decrease subtask and the asynchronous increase/decrease subtask every ten breathing cycles. Specifically, the practitioner first performs the subtask of synchronous increase/decrease of breathing and muscle force while counting his or her breathing cycles silently from 1 to 10, followed by the subtask of asynchronous increase/decrease of breathing and muscle force while counting the breathing cycles from 1 to 10, and then switches to the synchronous increase/decrease subtask, and so on, until the practitioner hears the beep informing that the training is all over. Obviously, the subtask of mixed increase/decrease of breathing and muscle force combines the three aforementioned subtasks thus is more difficult and requires more concentration for the practitioner to complete it.

In addition, in the tasks of synergic control of breathing and muscle force of the present invention, there are, no special requirements for the value of pressure force on the fingertips of the left and right index fingers of the practitioner, and it is sufficient that the practitioner feels comfortable and that the pressure does not exceed the range of the pressure sensor used in the tasks. There are no strict requirements for the amplitude of the abdominal breathing during the training, but the practitioner should keep the amplitude of the inhalation and exhalation as large as possible while feeling comfortable.

During the training stages, the “breathing-muscle force synchronization” indicator calculated from the practitioner's breathing signal and muscle force output signal is displayed in real time through the display module for the trainer to observe the practitioner's training performance and attentional state during the training process, so as to give the practitioner timely feedback and targeted guidance at the end of each training session.

In addition, during the training stages, if the calculated “breathing-muscle force synchronization” indicator exceeds a given threshold, it would be considered as a low attention level, a short beep will be given in the headset to alert the practitioner to the distraction and to refocus on the training task.

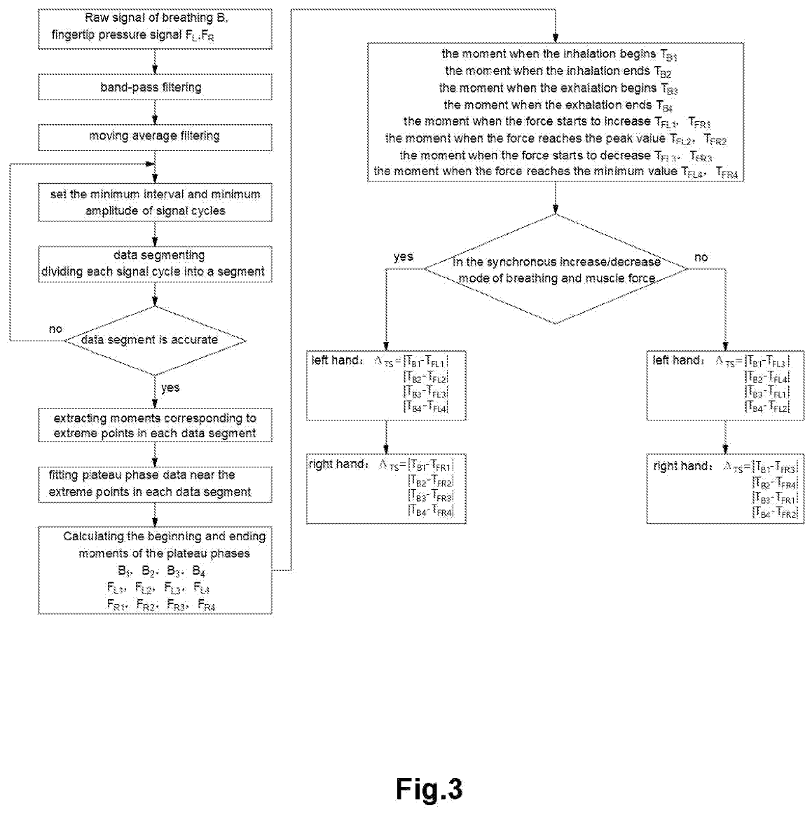

The “breathing-muscle force synchronization” indicator is denoted as Δ_{TS} in the present invention, which reflects the synchronization between the practitioner's breathing signal and muscle force output signal during the training process and is an external representation of the practitioner's internal attention state during the training. FIG. 3 shows a flow chat for calculating Δ_{TS} when the muscle force is a fingertip force in the present invention, and the process is as follows:

First, preprocessing the raw signal of breathing B, raw signal of the left index fingertip pressure FdL, and raw signal of the right index fingertip pressure F_{R} to remove obvious noise. For example, band-pass filtering (0.5-100 Hz) and moving average filtering are performed. The above filtering methods and parameters are only examples and do not constitute limitations.

Then, segmenting the breathing signal and fingertip pressure signal by setting an appropriate minimum interval and minimum amplitude of signal cycles, with each breathing cycle or force increase/decrease cycle divided into a segment, and checking the accuracy of the data segmentation. It should be noted that for different practitioners, the collected breathing and finger pressure signal cycles are different, so the parameters need to be adjusted to make the data segmentation accurate. The criteria for accurate data segmentation is that each segment includes only one peak and one trough. If the data segmentation is inaccurate, the set minimum interval and minimum amplitude of the signal cycle need to be readjusted. If the data segmentation is accurate, calculating the extreme points in each segment of data, including the extreme points and the minimal value points, and extracting the moments corresponding to the extreme values in each data segment.

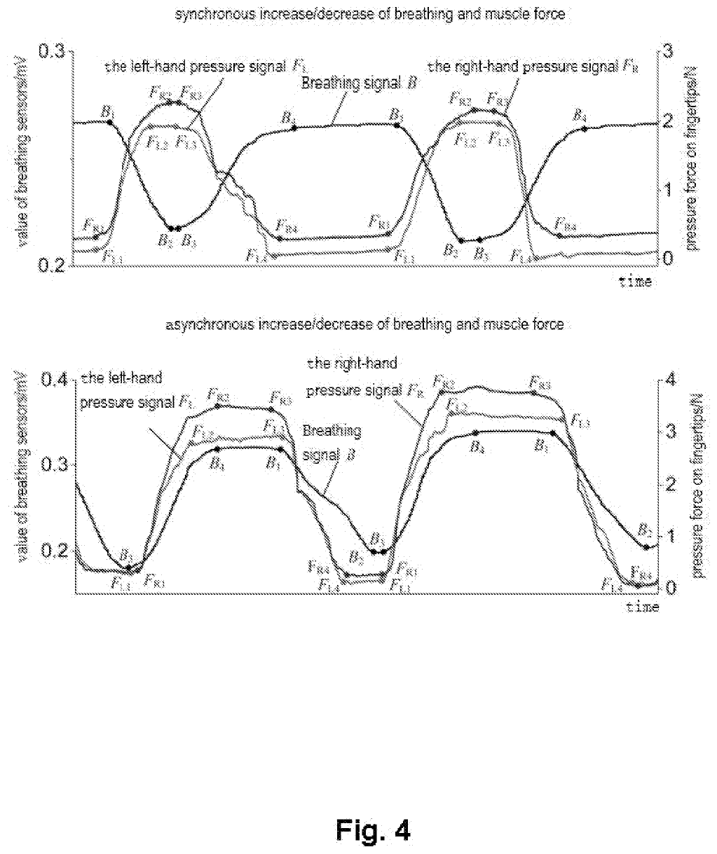

FIG. 4 is a schematic diagram of the curves of the breathing signal B, the left-hand pressure signal F_{L} and the right-hand pressure signal F_{R} collected in the subtask of synchronous increase/decrease of breathing and muscle force and the subtask of asynchronous increase/decrease of breathing and muscle force in the present invention. The curves and the corresponding values in the figure are only examples. The meanings of the points marked in the figure are as follows:

B₁: the point where the inhalation begins, B₂: the point where inhalation ends, B₃: the point where the exhalation begins and B₄: the point where the exhalation ends.

F_{L1}: the point where the pressure force of the fingertip of the left index finger starts to increase, F_{L2}: the point where the pressure force increases to a peak, F_{L3}: the point where the pressure force starts to decrease, F_{L4}: the point where the pressure decreases to a minimum.

F_{R1}: the point where the pressure force of the fingertip of the right index finger starts to increase, F_{R2}: the point where the pressure force increases to a peak, F_{R3}: the point where the pressure force starts to decrease, and F_{R4}: the point where the pressure decreases to a minimum.

The practitioner will naturally hold his/her breath for a few seconds before starting to exhale when the inhalation reaches its peak, and will also naturally hold his/her breath for a few seconds before starting to inhale when the exhalation is completed. As a result, a plateau phase occurs for a few seconds around the maximum and minimum value points in the collected breathing signals, for example, there are plateau phases of the breathing between B₄ and B₁ and between B₂ and B₃ in FIG. 4. Ideally, the breathing data remain constant or fluctuate very little during the plateau phases. Correspondingly, after the fingertip force reaches the maximum and minimum value, and is then held for several seconds, a plateau phase also occurs near the maximum and minimum value points in the collected pressure signal, for example, there are plateau phases of the left-hand pressure signal between F_{L2} and F_{L3} and between F_{L4} and F_{L1}; and plateau phase of the right-hand pressure signal between F_{R2} and F_{R3} and between F_{R4} and F_{R1}. In particular, the duration and amplitude of the plateau phases of the breathing signal and the finger pressure signal are not fixed in each data segment depending on the performance of the practitioner.

In the present invention, the essence of calculating the “breathing-muscle force synchronization” indicator Δ_{TS} is to calculate the beginning and ending moments of the plateau phases in the above-mentioned breathing signal and pressure signal, i.e., the points of B₁, B₂, B₃ and B₄ in the breathing signal; the points of F_{L1}, F_{L2}, F_{L3} and F_{L4} in the left-hand pressure signal; and the points of F_{R1}, F_{R2}, F_{R3} and F_{R4} in the right-hand pressure signal. The least squares method can be used to extract the plateau phases of each data segment by fitting the data near the maximum value points and minimum value points, and further calculate the beginning and ending moments of the plateau phases. However, the above method of calculating the beginning and ending moments of the plateau phases does not constitute a limitation.

Extracting the beginning and ending points of the plateau phases in each data segment of the breathing signal and finger pressure signal respectively, and obtaining the corresponding moments as follows:

T_{B1}: the moment when the inhalation begins, T_{B2}: the moment when the inhalation ends, T_{B3}: the moment when the exhalation begins, T_{B4}: the moment when the exhalation ends.

T_{FL1}: the moment when the force of the left index fingertip starts to increase. T_{FL2}: the moment when the force reaches the peak value, T_{FL3}: the moment when the force starts to decrease, and T_{FL4}: the moment when the force reaches the minimum value.

T_{FR1}: the moment when the force of the right index fingertip starts to increase, T_{FR2}: the moment when the force reaches the peak value, T_{FR3}: the moment when the force starts to decrease, and T_{FR4}: the moment when the force reaches the minimum value.

As mentioned above, the coordination between the inhalation/exhalation process and the increase/decrease of the pressure of the left and right index fingertips in the synchronous and asynchronous increase/decrease modes of breathing and muscle force is different. Therefore, when calculating the “breathing-muscle force synchronization” indictor Δ_{TS}, it is necessary to distinguish whether the current data is in the synchronous increase/decrease mode of breathing and muscle force or in the asynchronous increase/decrease mode. For the synchronous increase/decrease, 8 Δ_{TS} values can be calculated for each signal cycle as follows:

Left hand: Δ_{TS}=|T_{B1}−T_{FL1}|, |T_{B2}−T_{FL2}|, |T_{B3}−T_{FL3}|, |T_{B4}−T_{FL4}|

Right hand: Δ_{TS}=|T_{B1}−T_{FR1}|, |T_{B2}−T_{FR2}|, |T_{B3}−T_{FR3}|, |T_{B4}−T_{FR4}|

For the asynchronous increase/decrease mode of breathing and muscle force, 8 Δ_{TS} values can be calculated for each signal cycle as follows:

Left hand: Δ_{TS}=|T_{B1}−T_{FL3}|, |T_{B2}−T_{FL4}|, |T_{B3}−T_{FL1}|, |T_{B4}−T_{FL2}|

Right hand: Δ_{TS}=|T_{B1}−T_{FR3}|, |T_{B2}−T_{FR4}|, |T_{B3}−T_{FR1}|, |T_{B4}−T_{FR2}|

By calculating the Δ_{TS} in each signal cycle, the “breathing-muscle force synchronization” indicator during the whole training process can be obtained, so as to evaluate the change of the practitioner's attention during the training process and assist the trainer to give timely feedback and targeted guidance.

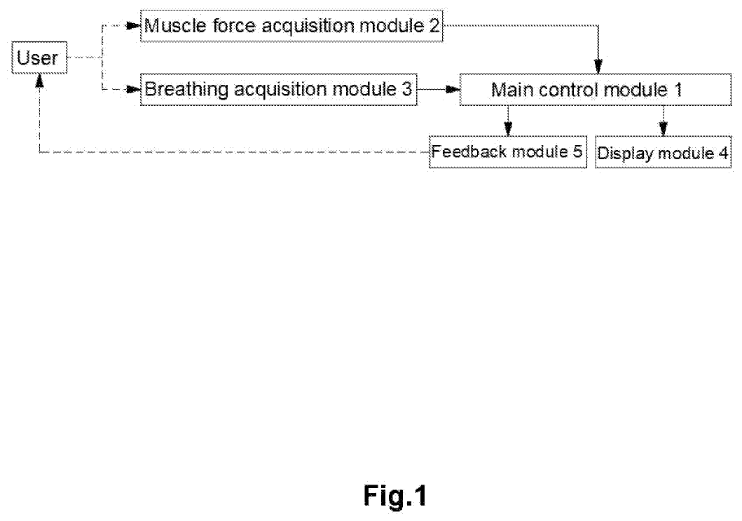

The present invention provides an attention training system based on tasks of synergic control of breathing and muscle force, and the hardware structure of the system is shown in FIG. 1, which mainly comprises: a main control module 1, a muscle force acquisition module 2, a breathing acquisition module 3, a display module 4, and a feedback module 5, wherein, the muscle force acquisition module 2 and the breathing acquisition module 3 are connected to the main control module 1, and the main control module 1 is connected to the display module 4 and the feedback module 5.

The main control module 1 is used to set the parameters before training and to calculate the “breathing-muscle force synchronization” indicator representing the attention state during the training, and to determine whether the user is currently at a low attention level by comparing this calculated indicator with a given threshold. The main control module 1 can be a host or a computer.

The muscle force acquisition module 2 includes a plurality of sensors and a voltage amplifier circuit connected to each sensor respectively. The sensors are used to collect muscle force signals and the number of sensors can be set according to the actual situation, for example, 1-10. In this embodiment, the sensors are pressure sensors, and the number of the sensors is 2, which collect the pressure signals from the fingertips of the left and right index fingers, respectively. The voltage amplifier circuit is used for amplifying the voltage signal and then transmitting it outward. The person skilled in the art can understand that the voltage amplifier circuit can also be a conventional circuit for amplifying the voltage signal.

The breathing acquisition module 3 includes a breathing sensor, and the breathing signal output from the breathing acquisition module 3 is a voltage signal, which is transmitted to the main control module 1.

The display module 4 may be a liquid crystal display for displaying the muscle force signal, breathing signal, and “breathing-muscle force synchronization” indicator transmitted from the main control module 1.

The feedback module 5 is used to provide the practitioner with a timely feedback in certain way on the “breathing-muscle force synchronization” indicator that represents the low attention level measured by the main control module 1. The feedback signal can be a vibrotactile signal mounted on the back of the hand or wrist, or a weak sound signal from the headset, etc. The feedback can be real-time or it can also be delayed in order to provide the user with a certain amount of time for self-regulation. The above-mentioned ways of feedback, are not a limitation and are not unique. In this embodiment, short beeps are, used for real-time feedback.

In addition, the above hardware structure of the present invention further comprises:

a base 11 for fixing the muscle force acquisition module 2;

anti-disturbance equipment, including an anti-noise headset 7 and an eyeshade 8.

The anti-noise headset 7 is used for isolating sound disturbance from the external environment during the training process.

The eyeshade 8 is used for isolating visual disturbance from the external environment during the training process.

The above embodiments are preferable embodiments of the present invention, but the implementation of the present invention is not limited by the above embodiments, any other changes, modifications, alternatives, combinations, simplifications made without deviating from the spirit and principle of the present invention shall be equivalent substitutions and are included in the scope of protection of the present invention.

What is claimed is:

1. An attention training method based on synergic control of breathing and force, characterizing by combining the characteristics of focusing on proprioceptive breathing during meditation with the characteristics of focusing on muscle force control in the haptic channel, and realizing visual detection of attention states during a training process through synchronization errors of breathing signals and force signals, wherein the method comprising:
(a) a breath counting subtask, wherein a practitioner focuses on his or her own breath and counts breathing cycles silently, with one inhalation plus one exhalation being recorded as one breathing cycle; wherein the training method further comprises one or more of the following three subtasks:
(b) a subtask of synchronous increase/decrease of breathing and muscle force, wherein the practitioner focuses on the breathing and the muscle force output at the same time, controls the muscle force output to increase steadily during inhalation, and keeps the muscle force output at the maximum value when the inhalation reaches the limit and a breath-holding state; then controls the muscle force output to decrease steadily during exhalation, and reduces the muscle force output to zero when the exhalation reaches the limit and the breath-holding state;
(c) a subtask of asynchronous increase/decrease of breathing and muscle force, wherein the practitioner focuses on the breathing and the muscle force output at the same time, and the muscle force output decreases to zero when the inhalation reaches the limit and the breath-holding state; controls the muscle force output to increase steadily during exhalation, and keeps the muscle force output at the maximum value when the exhalation reaches the limit and the breath-holding state; and
(d) a subtask of mixed increase/decrease of breathing and muscle force, wherein the practitioner focuses on the breathing and the muscle force output at the same time and switches between the synchronous and asynchronous increase/decrease subtasks in groups of several breathing cycles.

2. The attention training method based on synergic control of breathing and force according to claim 1, wherein the four subtasks of (a)(b)(c) and (d) have progressively increasing training difficulty and are used for the attention training independently or consecutively in a progressive manner.

3. The attention training method based on synergic control of breathing and force according to claim 1, wherein the muscle force is a fingertip force.

4. The attention training method based on synergic control of breathing and force according to claim 1, wherein the practitioner's breathing type is abdominal breathing.

5. The attention training method based on synergic control of breathing and force according to claim 1, wherein the synchronization error between the breathing signal and the force signal is represented by a “breathing-muscle force synchronization” indicator, which reflects the synchronization between the breathing signal and the muscle force signal of the practitioner during the training process and is an external representation parameter of the practitioner's internal attention state during the training process.

6. The attention training method based on synergic control of breathing and force according to claim 5, wherein the “breathing-muscle force synchronization” indicator is obtained by following steps: band-pass filtering and moving average filtering of the raw signals of breathing and muscle force to remove obvious noise, and segmenting the breathing signals and muscle force signals, respectively, according to pre-set appropriate minimum intervals and minimum amplitudes of signal cycles, wherein each breathing cycle or muscle force increase/decrease cycle is divided into one segment, and calculating extreme points in each segment, including the maximum value points and the minimum value points, extracting moments corresponding to the extreme points in each segment, extracting plateau phases near the extreme points by data fitting, and further calculating the beginning and ending moments of the plateau phases in each segment.

7. An attention training system based on synergistic control of breathing and force, for implementing the attention training method of claim 1, comprising:
a main control module, a muscle force acquisition module, a breathing acquisition module, a display module, and a feedback module, wherein the muscle force acquisition module and the breathing acquisition module are arranged to be connected to the main control module respectively and the main control module is arranged to be connected to the display module and the feedback module;
the muscle force acquisition module is configured to collect muscle force output signals; the breathing acquisition module is configured to collect breathing signals;
the main control module is configured to be used to set parameters before the training, to calculate the “breathing-muscle force synchronization” indicator representing the attention state during the training and to detect a low attention level;
the display module is configured to display the muscle force output signals, the breathing signals and the “breathing-muscle force synchronization” indicator transmitted from the main control module;
the feedback module is configured to feed back the “breathing-muscle force synchronization” indicator representing the low attention level detected by the main control module to the practitioner in real time in the form of short beeps.

8. An attention training system based on the synergistic control of breathing and force according to claim 7, further comprising a base for holding the muscle force acquisition module.

9. An attention training system based on the synergistic control of breathing and force according to claim 7, further comprising anti-disturbance equipment for isolating the disturbance of external environment.

10. An attention training system based on the synergistic control of breathing and force according to claim 9, wherein the anti-disturbance equipment comprises an anti-noise headset or an eyeshade.
